(19) United States
(12) Patent Application Publication
(10) Pub. No.: US 2024/0414497 A1
(43) Pub. Date: Dec. 12, 2024

(54) HISTORICAL LOCATION RECOMMENDATION AND INFORMATION SYSTEM AND METHOD

(71) Applicant: Jack McIntyre, San Angelo, TX (US)

(72) Inventor: Jack McIntyre, San Angelo, TX (US)

(21) Appl. No.: 18/732,996

(22) Filed: Jun. 4, 2024

Related U.S. Application Data
(60) Provisional application No. 63/471,899, filed on Jun. 8, 2023.

(51) Int. Cl. H04W 4/021

(52) U.S. Cl. CPC H04W 4/021

(57) ABSTRACT

A historical marker content transmission unit for transmitting first historical marker content associated with a first historical marker according to an acceptance message sent to the historical content marker request platform and second historical marker content associated with the first historical marker according to predefined parameters selected by the user and stored in a database associated with historical marker content request processing platform.

### PRIORITY

The present invention claims priority to U.S. Provisional Application No. 63/471,899 filed Jun. 8, 2023, the entirety of which is hereby incorporated by reference.

### BACKGROUND OF THE INVENTION

### Technical Field

This disclosure relates generally to systems and methods for providing historical marker information to mobile users.

### BACKGROUND

Historical markers are signs or other indicators that are placed at a geographic location of significance. The significance of the location may be that it was the site of a historical battle or of an event of note. Historical markers are placed to identify the birthplace or place of death of an important or notorious person. There are many such markers in places like Gettysburg where numerous Civil War battles took place. There is a marker in Gibsland, Louisiana to identify the place where notorious criminals Bonnie and Clyde were shot down after evading authorities for years.

Many motorists and travelers pass by these historical markers frequently and perhaps even the same ones daily. But in view of today's busy lifestyles, traffic and other demands, very few people actually stop and read what these markers have to say. Unfortunately, thousands and thousands of people miss the opportunity to learn of what may have been a fascinating historical event that took place on the very spot on which they stand. There is a need, therefore, to provide motorists and travelers with information concerning the significance of a historical site, including directions how to get to it, means for sharing the information gleaned with others, and possible other locations and materials of interest.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a network diagram of a historical content platform according to an embodiment.

FIG. 2 is a diagram of a historical content platform in communication with a mobile user device according to an embodiment;

FIG. 3 is a flow diagram of a method performed by or in connection with the historical content platform according to an embodiment;

FIG. 4 is a flow diagram of a method performed by or in connection with the historical content platform according to an embodiment;

FIG. 5 is a flow diagram of a method performed by or in connection with the historical content platform according to an embodiment;

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

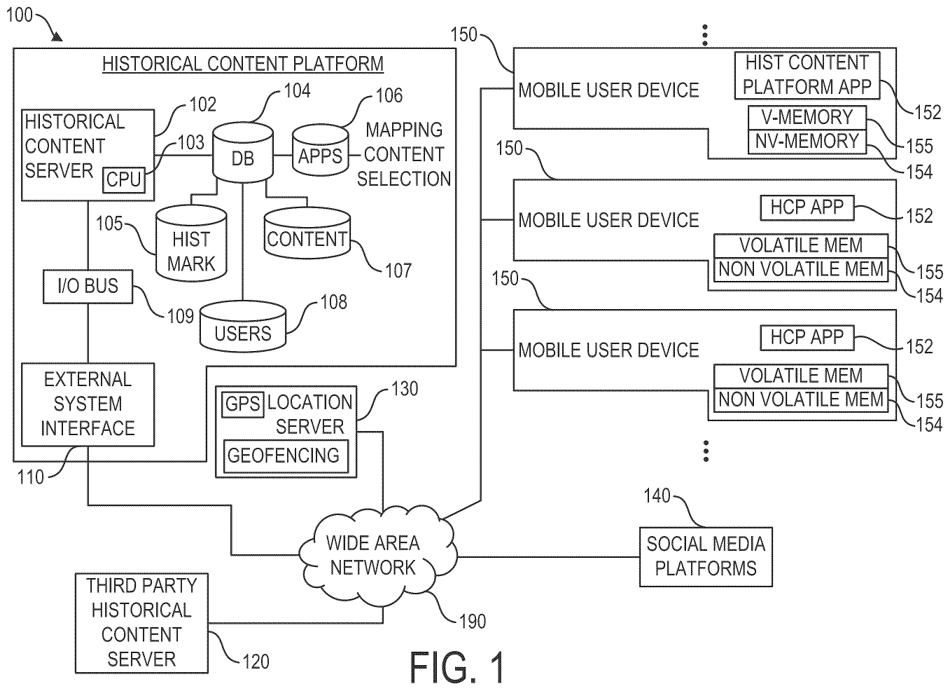

Embodiments of the present disclosure and its advantages are best understood by referring to FIGS. 1 through 5 of the drawings, like numerals being used for like and corresponding parts of the various drawings.

In one embodiment, the system is an application program executed on a computer, smart phone, tablet or any device having communication network connectivity via a wired or wireless network and/or internet capability. The application program operates as a platform through which information concerning historical locations is pushed to or requested by users having a customized application program stored on a mobile device, such as a smartphone, tablet, personal digital assistant or the like. Information related to the historical marker or site is transmitted to a user enrolled in a dedicated content provider program. The enrollment can entail a monthly subscription arrangement where the user pays a monthly fee to keep the service active. Alternatively, a lump sum payment may be made by the user to permit access and use of the presently described historical content platform for a predefined length of time, with the finite period extendable by the user according to terms offered by the platform operator.

Users enrolling in then historical content platform of the present invention have the option of enrolling in an advertisement free service plan or one in which advertisements are transmitted to the user's device. The advertisement free service plan typically is more costly than the “with ads” service, with the “with ad” service being free or at a low monthly payment, as is the choice of the platform operator. As will be described, the platform operator of the presently described historical content platform offers many customizable programs to user, enabling subscribing users to purchase and activate features through a dedicated application program that provides the most effective manner to receive historical content of interest.

FIG. 1 is a network diagram of a historical content platform according to an embodiment. In FIG. 1, historical content platform 100 is shown, which performs much of the features and functionality of the presently described invention. Historical content platform 100 comprises historical content server 102, that itself comprises a central processing unit 103 and has an associated database 104. Database 104 includes historical marker information 105, application programs 106 that control mapping and content selection based on the particular historical marker of interest and particular parameters set by the user. Database 107 includes other content related to historical marker information 105. This other content includes location information, data concerning the historical marker information previously sent by historical content platform 100 to users or other parties, as well as advertising and marketing information, which will be discussed. Database 108 includes user information such as user account information that in one embodiment includes a user's associated financial account information through which user payment for the services offered through historical content platform 100 is provided to users, as well as user preferences and profile information. The user in one embodiment is assigned a unique identifier that is based on an email address, a phone number or other unique collection of numbers, letters or special characters that uniquely identifiers a users establishing service with historical content platform 100

Application programs 106 include various software modules or code that when executed causes various features and functionality of the historical content platform 100 to be invoked. A mapping application program included among application programs 106 processes mobile user location data received from historical content platform 100. This invokes content selection application programs of application programs 106 to cause transmission of historical marker data or other content to be sent to the user based on the user's location. This mapping capability may be achieved through the receipt by historical content platform 100 of global coordinate data through known global positioning system (GPS) techniques. In the alternative, geo fencing technology is employed, where a virtual fence having a predefined radius from a historical marker of interest or a boundary around the marker is established using known geo fencing techniques. Once a user's mobile device comes within the predefined boundary, an indication that the user is in the vicinity of a historical marker. In the alternative, a user subscribing to historical content platform 100 can link his or her automobile GPS or navigation system to historical content platform 100 so that the vehicle's navigation system, rather than the user's mobile phone, invokes the information exchange between historical content platform 100 and the user based on the vehicle's location.

In one embodiment, once a user with mobile device 150 encroaches the predefined geo-fence surrounding a first historical marker, other historical markers within a predefined distance from the first historical marker and the next historical marker invokes a mapping capability. Through this mapping capability computer readable code stored in applications datastore 106 retrieves route information between the first historical marker and the next. This information is transmitted to the user mobile device 150, allowing the user to efficiently travel between markers, providing various road or walking path options. Should a third historical marker reside within the predefined distance of the first or second historical markers, or both, the recommended route of travel between the three markers is provided to the user. This feature is particularly useful in places that are densely populated with historical sites, such as Williamsburg, Virginia and Gettysburg, Pennsylvania.

If the user transmits and indication of interest, the content selection module of application programs 106 transmits content concerning the nearby marker and other information. Alternatively, the user is presented with the option to receive other information and content about the present marker of interest and of other markers within a certain predefined distance of the user. In one embodiment, known map applications programs are also invoked via the user's historical marker application program stored on the user's device to provide the user with driving or walking directions to the marker and direction to other markers within a predefined distance from the current marker.

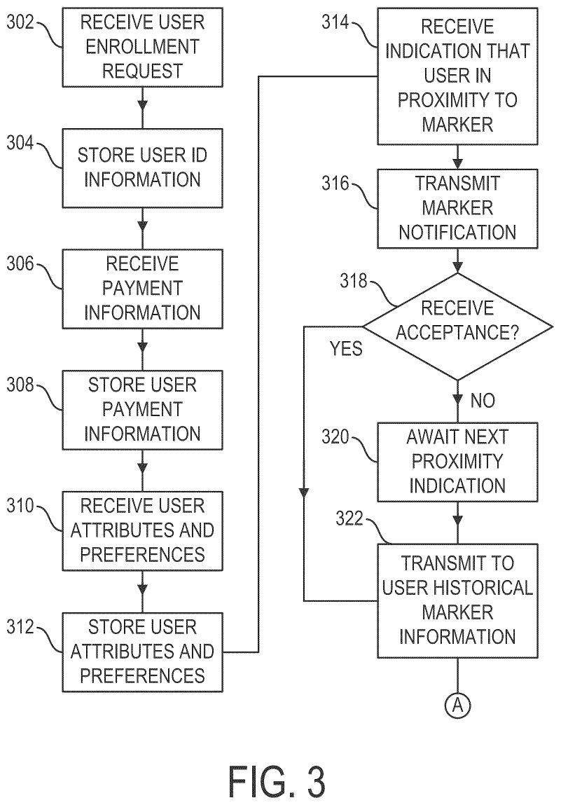

An embodiment of the features and functionality of historical content platform 100 that are carried out by execution of application programs 106 and the dedicated application program stored on the mobile user device are described in detail in FIG. 3-5.

Application programs 106 comprise computer readable code stored in non-volatile memory associated with processor 103 of historical content server 102. Execution of the computer readable code causes the various software modules governing operation of the historical content platform to be invoked and control the functionality of the historical content platform.

Content database 108 includes various information associated with historical markers, that relate to historical marker data stored in historical marker data store 105. Historical marker data store 105 includes basic data concerning the marker, including the location of each marker for which content is provided through historical content platform 100 and a summary description of the information provided on the marker itself. That is, the date or dates relevant to the marker (such as birth date, battle date, death date, etc.) and the text that appears on the marker. Content datastore 107 contains additional information in connection with the marker that is transmitted to subscribing mobile users. The contents of historical marker data store 105 and content datastore 107 are in separate datastores as described or stored together in a single storage location.

Content datastore 107 contains produced information beyond what a visitor sees and reads on the physical marker. This information includes audio and video files that include narration of the writing on the marker itself, which assists the visually impaired and allows anyone to listen to narration of the words on the marker while driving, hiking, etc. Content datastore 107 also contains documentary style materials in audio and video form that are transmitted to the mobile user equipped with the historical marker platform dedicated application program on his or her mobile device. By example, at the Bonnie and Clyde marker in Louisiana denoting the couple's death, audio and video materials describing the criminal careers of the duo along with images of headlines of the period, various heist information and the like is transmitted to the mobile user. This expands mere reading of the paragraph or two at the marker into a virtual museum visit or history lesson about the historical figure or place. Content datastore 107 optionally includes other materials that may be of interest to the mobile user, such as related books, audio books, movies, podcasts, points of interest, products and other goods or services that in some way have a connection to the location, context or substance of the historical marker. It is contemplated that that historical content platform 100 is operated by a historical society or other institution such as a university. As such, these parties may develop their own additional content about the historical marker and underlying facts. These self-produced information products in one embodiment are stored locally in content datastore 107 as it is assumed that no license would be required by the historical content platform operator to distribute its own content to users. As will be discussed, however, the operator of historical content platform 100 can certainly make available to users third party generated content, which can reside in content data store 107 or provided via third party historical content server 120. Either way, historical content platform 100 has access to significant and diverse content related to the substance and geography of the historical marker that is sent to the user.

This additional content poses a revenue generating avenue for operators of historical content platform 100 in that it offers the ability to provide targeted advertising and product promotion to users. This provides the operator of historical content platform 100 with the opportunity for corporate partnerships, sponsorships and the like.

User datastore 108 contains user information submitted by the user when subscribing to the historical content platform 100 service. User information includes a user name and a login password as is customary, that serves as a unique identifier of the user of the platform. The user information also includes user financial account information through which a flat fee or monthly subscription fee is paid to the historical content platform operator from the user. The financial information can be credit or debit card information, bank account information, such as a bank account number of the user from which payments are drawn, a gift card number, a third party payment vendor (such as PayPal), or payment may be made by application programs associated with the user's device, such as Google Wallet or Apple Pay. Other known payment vehicles may be employed and the user submits the relevant payment account information to the historical content platform operator to facilitate payment, with such information stored in user datastore 108.

User datastore 108 also contains user information provided by the user, such as various user attributes. This includes the user's address, phone number, and contact information. The user optionally provides more detailed demographic information such as age, gender, and various user interests. These attributes are aggregated by the platform operator and through predictive software modules stored in applications data store 106, the user is provided with various items of interest. These items of interest include but are not limited to other historical markers, either in close proximity to the user's current location or beyond, goods and services for sale that may be of interest to the user, and the like.

User datastore 108 also includes various functionality settings selected by the user. In one embodiment, the user via the dedicated application associated with historical content platform 100 that the user uploads and installs on her mobile device allows the user to select various features. These selections include but are not limited to user distance from a historical marker that invokes platform 100 to send a notification to the user device of a nearby marker. Also, the user can opt to filter out and, therefore, not receive any historical marker information if the historical marker pertains to information that is of no interest to the user. The user, for example, may wish to avoid any notifications concerning markers of places signifying the death of a person. Through the dedicated application program the user is presented with various topics that the user wishes to filter out as well as provided a space to provide freeform keywords provide the basis for the filtering feature. The user may also wish to limit notification to a certain time of day or in certain towns, cities or states. Such selections are stored in user datastore 108 and are applied by platform 100 in determining what content to send the user and when. Through the dedicated application program installed on the user device, the user is able to have a fully customized experience, receiving notifications of historical marker from platform 100 and particularized content.

The mobile user through the dedicated application program installed on the mobile user device also includes a user interface for the user to select or create a geo-fence surrounding known markers of interest. This feature is particularly useful when a user expects to be at a particular location for vacation or otherwise and wishes to set in advance receipt of notifications, enabling users to map out a course of travel to fully experience the various historical locales.

Optionally, in an embodiment, a user uploads a photograph of the marker to the mobile device via the dedicated application program installed on the mobile device. This causes platform 100 to search for the corresponding image stored in historical marker datastore 105 to establish a match between the image uploaded by the user and the contents of datastore 105. Once a likely match is recognized by platform 100, the user is sent a message asking the user to confirm the name of the historical marker of interest. If the user so confirms, platform 100 sends the user an interface presenting for selection various content information stored in content datastore 107 associated with that historical site. If the user does not confirm the match, platform 100 continues to search historical marker datastore 105 for the next possible match until the user confirm the marker or exits the feature.

Continuing with FIG. 1, historical content server 102 communicates with input/output bus 109, through which historical content server 102 communicates for historical content platform 100 via external devices via external system interface 110. Communication between platform 100 and mobile users 150 and third party platforms occurs via wide area network 190, which includes the internet and/or a cellular network or the like. Such external platforms include banking networks (not shown) to process user payments, third party historical content server 120, location server 130, which includes a GPS and/or a geo-fencing software module, and social media platforms 140.

Users communicate with historical content platform 100 via wide area network 190 through mobile devices 150, which are smart phones, personal computers or personal digital assistants or other user devices having a processor and operating system. Mobile device 150 also includes a radio or receiver in a user's vehicle. Through an application program installed in storage connected with the user's vehicle media system, the user can execute the functionality of offered through historical content platform 100 and the dedicated application programs downloaded by the user via the user's vehicle display and corresponding controls. That is, the vehicle's entertainment system has stored thereon the same historical content mobile applications 152 as would be downloaded on the user's smartphone device, as described below.

Similarly, the user electing to install the vehicle entertainment system version of historical content mobile applications will listen to content including audio files relating too the historical marker through the vehicle's speakers connected to the radio or entertainment system. For purposes of the discussion of the methods of the embodiments discussed below, it is assumed the mobile user device is a smart phone but a user radio/entertainment system is equally effective as the receiver of the information. Moreover, the user of a mobile device that is a smart phone can link the smartphone to the vehicle entertainment system via the Bluetooth network protocol or other known wireless or wired network protocol, enabling viewing of content received from historical content mobile applications 152 on the vehicle's screen, through the vehicle's speakers and the like.

Historical content platform application program 152 is uploaded by the user from known platforms from which users upload application programs and is stored in non-volatile memory 154 of mobile device 150. Historical content application program 152 provides a graphical user interface on the display of mobile user device 150 making the various user selectable features and functionality of historical content platform 100, and ultimately content of interest, available to the user on mobile user device 150. It is assumed that users of mobile user devices 150 are subscribers to various networks such as a cellular network or have available wired or wireless communications in the case of a personal computer to communicate with historical content platform 100 via wide area network 190.

Mobile user device 150 also comprises volatile memory 155, in which certain data and information is presented to the user and made available while the mobile device is powered on and historical content platform application program 152 is open. Such information that is stored temporarily for the user in volatile memory are uploaded photos or profile or preference selections or other information retrieved from non-volatile memory to provide the user with the ability to make additional use of such information.

In an embodiment, a third-party historical content server 120 communicates with historical content platform via network 190. Third party historical content server 120 is associated with a single third party or multiple third parties to provide content to historical content platform 100. In this context, historical content platform 100 acts as an information aggregator of content retrieved from third party historical content server 120. Such content includes various pre-produced audio and video content regarding various aspects of the historical marker, as discussed above. Additional items such as audio books or films or other produced content is retrieved by historical content platform 100 and saved in content datastore 107 for ultimate access by a subscribing mobile user. The operator of historical content platform 100 can purchase or license third party content on the various historical markers. Historical content platform 100 makes requests for information from third party historical content server 102 communicates via external system interface 110.

Continuing with FIG. 1 location server 130 provides historical content platform 100 with GPS location and geo-fencing capability, using known techniques. In one embodiment, the administrator of historical content platform 100 employes GPS or geo-fencing techniques made available through location server 130 to set predefined boundaries or coordinates associated with a historical marker. For example, as a default rule, a subscribing user receives a notification when passing within ten miles of a historical place. The administrator of historical content platform 100 retrieves the GPS coordinates of the marker based on its address and established a boundary therefrom. Once a user enters the geo-fence or boundary, the user will retrieve a notification of the historical marker and from there can proceed to receive additional information and content or ignore the notification. This location set by the administrator is the default boundary. The user via mobile device 150 and historical content application program 152 stored thereon is able to reset the distance from the marker in which the user must pass in order to invoke notification transmission from historical content platform 100.

Continuing with FIG. 1, in an embodiment mobile devices 150 and historical content platform 100 communicate with various social media platforms 140 via network 190. Social media platforms 140 communicate with historical content platform 100 enabling the operator of historical content platform 100 to have its own presence on various social media outlets to promote platform 100 and its offerings. At the same time, users via mobile user devices 150 access their respective social media accounts directly through the historical content platform application program 152 installed on mobile device 150. This allows direct postings by the user of content or information gleaned during the historical marker content experience offered users via historical content platform 100 in a most efficient manner.

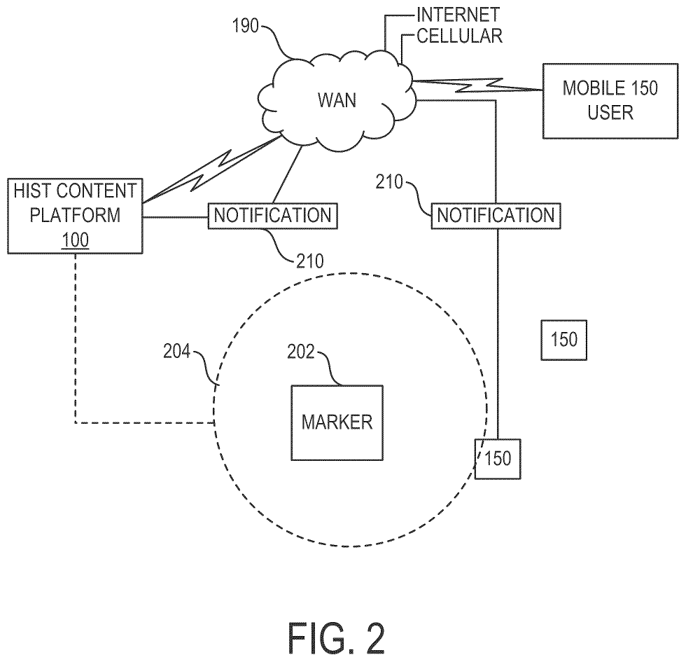

FIG. 2 is a diagram of a historical marker for which a geo-fencing boundary has been established. In FIG. 2, historical marker 202 is shown. The location of historical marker 202 can be anywhere. The GPS coordinates of historical marker 202 are known and stored in historical marker 105 datastore of historical content platform 100. In one embodiment, mapping program among application programs stored in application programs datastore 106 in historical content platform 100 operate to set a geo-fence boundary 204 about marker 202. The radius or perimeter of geo-fence boundary 204 is set by the user via the dedicated application program installed on mobile device or set as a default setting by the administrator of historical content platform 100.

Once the virtual boundary 204 is established, the GPS coordinates of a subscribing user's mobile device 150 are periodically collected by historical content platform 100. Once the GPS coordinates are of a geographic location that overlap with border of boundary 204, a notification generation module within applications datastore 106 generates a notification of which marker the user is approaching. This notification includes the marker name, the location and distance from the user. Optionally, the notification includes a link to directions to the marker via known map application programs. As discussed, mobile devices 150 and historical content platform 100 communicate via wide area network 190, which comprises one or more of the internet or cellular network.

As discussed, once the notification is received by the user that the user is approaching a marker, the user has the option to accept the notification or ignore it. If accepting, historical content platform 100 transmits additional information to mobile user device 150, enabling the user to read, view or listen to information concerning the marker, and receive additional content.

Methods embodied in the computer readable code of the various software modules or application programs as described are now discussed in relation to the flowcharts provided in various figures.

FIG. 3 is a flow diagram of a method performed by or in connection with the historical content platform according to an embodiment. FIG. 3 depicts in part steps of the process of a user subscribing to the historical marker platform service as described herein. A user who learns of the services available through historical marker content platform 100 through advertising, word or mouth or the like typically downloads the dedication computer program application program developed for communication with historical marker content platform 100 through a remote device, such as mobile user device 150 as described. Mobile user device 150 communicates with historical marker content platform 100 via wired or wireless connection over wide area network 190 according to various network communication protocols.

The user wishing to enroll downloads and installs on her device historical content platform application program 152, typically by activating downloading and installation through common application program repositories such as Google Play or the Apple Store or the like. Once the user installs historical content platform application program 152, the application program requires the user to follow various steps and input various information to subscribe. This information is typical and results in the user having an account with platform 100 that is unique to that user.

The method of FIG. 3 begins at step 302 where historical content platform 100 receives a request from a user to subscribe to receive content via historical content platform 100. The user enters the required information such as a username and password and transmits this information to historical content platform 100. If the username is in fact unique from the historical content platform 100 viewpoint, historical content platform 100 stores the user enrollment information in user datastore 108 at step 304. Next, at step 306, the user submits payment information via the user interface presented to the user via historical content platform application program 152 stored in non-volatile storage on mobile user device 150. This payment information pertains to a user credit or debit card, gift card, bank account, or third party vendor payment platform through or from which payment of the monthly or flat fee to subscribe to historical content platform 100 are drawn or paid. This payment information is stored in user datastore 108 at step 308 so that repeat payments can be automatically made by the user. The user in one embodiment is able to select an “ad free” subscription, which typically entails higher fees than a “with ads” subscription, or the user may select an “with ad” subscription.

Continuing with FIG. 3, at step 310 the user is presented with an interface by historical content platform 100 on mobile user device 150 permitting the user to customize and set preferences concerning the content that the user will receive, when it receives it, and what causes the user to be notified of a nearby historical marker. In one embodiment, the preferences choices include but are not limited to, the substance of the marker that is of interest to the user, the location of the marker associated with the content, the distance the user must come within the marker in order to receive a notification, and forms of content that the user wishes to receive and not receive, such as audio files, video files, motion picture recommendations, links to relevant items for purchase, and other produced content, times of day the user wishes to receive notifications, the city, state, county or country in which the historical place rests. These user selectable options give the user a fully customized experience in terms of receiving or not receiving historical marker content. At step 312 historical content platform 100 stores the user's preferences and other attributes in user datastore 108.

Continuing with step 314, historical content platform 100 receives an indication via the antenna and GPS capability of the user's device that the user has encroached a boundary of a marker. Once the user encroaches the predefined or user defined boundary surrounding a historical marker (as shown and discussed in FIG. 2), at step 316 historical content platform 100 sends mobile user device 150 a notification that the user has encroached a marker boarder. This notification includes the name and/or subject matter of the marker and a key that permits the user to indicate whether the user is interested in this marker and its associated information.

At step 318, platform 100 queries whether the user has sent a message that she is interested in receiving content of interest about the nearby marker. If the answer to this query is “no”, the process continues at step 320 and historical content platform 100 awaits the next notification that a user has encroached a marker boundary 204. If the answer is “yes” then, the process continues to step 322 where historical content platform 100 transmits to user historical marker information stored in historical marker store 105. This information in one embodiment is basic marker information that in essence presents to the user the same information that the user would see if physically standing at the marker.

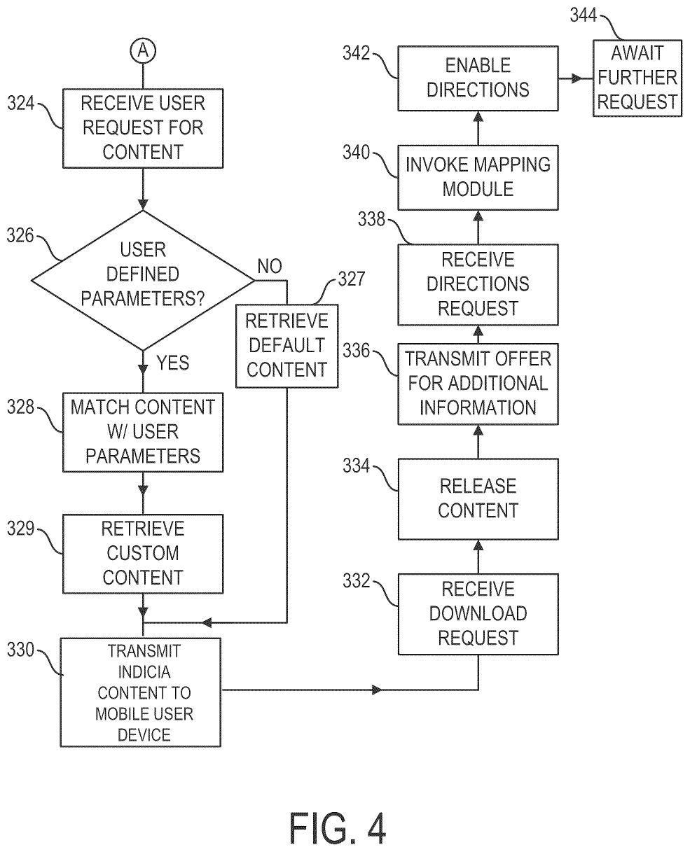

The method depicted according to the embodiment of FIG. 3 after step 322 continues at point A at the start of FIG. 4. The process of FIG. 4 continues from FIG. 3 at step 324 where following another user encroaching a marker boundary, historical content platform 100 receives a user that marker content is requested. Next at step 326 the platform queries whether there user datastore 108 for that user contains user defined parameters. If the answer is “no” the platform retrieves default content at step 327, which comprise basic marker information, as described. In an embodiment, the user can set the default information to be sent at the time of enrollment or later via the historical marker platform application 152 stored on user device 150. On the other hand, if the answer at step 326 is “yes”, then the method proceeds to step 328 where historical content platform 100 matches content with the user parameters. Next at step 329, historical content platform 100 retrieves custom content. This custom content comprises digital content from historical content datastore 105 and/or third party historical content server 120, depending on the user's parameters and the source of the various historical information.

Continuing with FIG. 4, at step 330, the user will be presented with indicia of the transmitted content on the user interface on the screen of mobile user device 150. Next, at step 332 historical content platform 100 receives a user request to download content, which includes podcasts, images, and other digital content. In response, historical content platform 100 releases the content at step 334. This release takes the form of sending mobile user device a message such as an SMS, instant message, email or the like with the relevant content file attached. In the alternative, the user is sent a link through with it accesses the content which resides remotely at one of the datastores of historical content platform 100 or at a third party server, or multiple links to access both.

At step 336, historical content platform 100 transmits to a user an offer for additional information. This offer includes providing directions, information of products for sale or driving or walking directions from the user's current location to the marker site. In an embodiment the additional information includes premium content, which the operator of historical content platform 100 may provide to the user for an additional fee or if the user enrolled in a plan that includes premium content. The additional content is not limited to a particular type of information, a source of information or the substance of the information, as long as it is deliverable to the mobile user device 150.

Upon receipt of a directions request by historical content platform 100 at step 338, the method proceeds to step 340 where historical content platform 100 invokes a mapping module stored in application datastore 106. Mapping module in an embodiment at step 342 enables driving or walking direction in the form of a map transmitted to mobile user device 150, in addition to textual directions and a corresponding audio file that the user can listen to while driving and making her way to the site. The method of FIG. 4 ends at step 344 with historical content platform 100 awaiting another request from this user or receiving another indication that a user of historical content platform 100 has encroached the boundary surrounding historical marker 202.

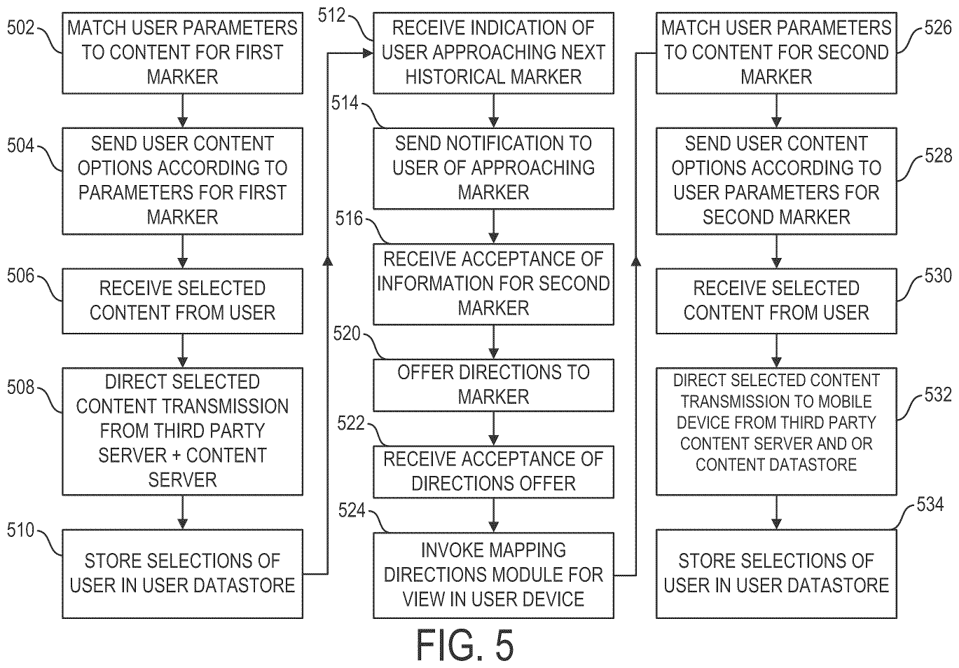

FIG. 5 is a flow diagram of a method performed by or in connection with the historical content platform according to an embodiment. Some of the steps of the flow diagram of FIG. 5 are similar to steps in prior flow diagrams. In addition, in FIG. 5 the scenario multiple historical markers are encroached by a user historical content platform 100 responds and transmits information accordingly.

The method of FIG. 5 begins where once a user encroaches a boundary about a marker, the user in fact requests basic marker content, then at step 502 historical content platform 100 matches user parameters to content available for a first marker. At step 504, historical content platform 100 sends to user content options according to the match between the predefined user parameters and the first marker. At step 506, user via mobile user device 150 sends to historical content platform 100 its selections among the presented options for additional content. At step 508, historical content platform 100 directs third party historical content server 120 to transmit content corresponding to the user's selection to the user device. The user will be presented with indicia of the transmitted content on the user interface on the screen of mobile user device 150. Next at step 510 historical content platform 100 stores the user selection in user datastore 108 for later use by predicting software of historical content platform 100 to more efficiently offer user content options for future markers visited by the user.

Whether or not the user has selected and received content for the first historical marker, during the user's travels the user may encroach a boundary of a second historical marker. When this occurs, historical content platform 100 at step 512 receives an indication of a user approaching a second historical marker. At step 514 historical content platform 100 transmits to the user's mobile user device 150 a notification of an approaching marker. Next, historical content platform 100 receives an acceptance message for information concerning the second marker to the user at step 516. Then at 520 the user is sent by historical content platform 100 an offer for to receive various content and an offer to receive driving or walking directions to the second historical marker. At step 522 historical content platform 100 receives from mobile user device 150 an acceptance of the offer for direction.

In one embodiment, If the user encroaching the boundary for both the first marker and the second marker, and the user has not yet visited the first marker or the second marker, historical content platform 100 invokes at step 524 mapping module of application programs 106 to send a map with highlights offering various routes of travel for the user to visit both markers, from the users current geographic location. Historical content platform 100 leverages GPS modules internal to historical content platform 100 or location server 130 to compile the directions. If the user encroaching the second marker is different than the user encroaching the first marker, then the method proceeds as described in FIG. 4 for a separate user and the mapping of a travel route for multiple markers is not invoked.

Next at step 526, historical content platform 100 matches the user parameters of the user encroaching the boundary of the second marker. Next at step 528, historical content platform 100 sends to mobile user device 150 of the user encroaching the second marker content options according to the users predefined parameter after matching the parameters to the information associated with the second marker. Next at step 530, historical content platform 100 receives the selected options from mobile user device 150. At step 532, historical content platform 100 directs transmission to mobile user device 150 of this user from third party historical content server 120, content datastore 105 or both, information and content relating to the second marker, depending on the user defined parameters. Finally, at step 534, the user's selection of content as its relates to the second marker are stored in user datastore 108, enabling historical content platform 100 to make efficient use of the information with predictive or artificial intelligence software for future user visits.

While the above-described flowcharts have been discussed in relation to a particular sequence of events, it should be appreciated that one or more changes to this sequence can occur without materially effecting the operation of the embodiments. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable. Moreover, the steps in the flowcharts are optional, with some of or all of the steps being performed.

The above-described methods and systems and can be implemented in a software module, a software and/or hardware testing module, a telecommunications test device, a DSL modem, an ADSL modem, an xDSL modem, a VDSL modem, a linecard, a G.hn transceiver, a MOCA transceiver, a Homeplug® transceiver, a powerline modem, a wired or wireless modem, test equipment, a multicarrier transceiver, a wired and/or wireless wide/local area network system, a satellite communication system, network-based communication systems, such as an IP, Ethernet or ATM system, a modem equipped with diagnostic capabilities, or the like, or on a separate programmed general purpose computer having a communications device or in conjunction with any of the following communications protocols: CDSL, ADSL2, ADSL2+, VDSL1, VDSL2, HDSL, DSL Lite, IDSL, RADSL, SDSL, UDSL, MOCA, G.hn, Homeplug® or the like.

Additionally, the systems, methods and protocols of this invention can be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable means, or the like. In general, any device (or one or more equivalent means) capable of implementing a state machine that is in turn capable of implementing the methodology illustrated herein can be used to implement the various communication/measurement methods, protocols, and techniques according to this invention.

Furthermore, the disclosed methods may be readily implemented in software stored on a non-transitory computer-readable storage media using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Modifications, additions, or omissions can be made to the methods depicted in FIGS. 3-5. The method can include more, fewer, or other steps. For example, steps can be performed in parallel or in any suitable order. While discussed as estimate generating system 100 (or components thereof) performing the steps, any suitable component of the estimate generating system can perform one or more steps of the method.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as falling within the scope of the appended claims.

### ADDITIONAL DISCLOSURE

Clause 1. A historical marker content request processing platform, comprising:
a processor having an operating system and programmed with executable computer readable code that when executed is programmed to function as:
a user mobile device position unit that identifies when a mobile device of a user enters a virtual boundary surrounding a first historical marker having a location corresponding to global positioning system (GPS) coordinates, the user mobile device position unit acquiring mobile user device location information for a plurality of uniquely identified users; vehicles having different vehicle damage regions, the vehicle damage information comprising images of vehicle damage information obtained from a depth and dimension measuring device;
a historical marker content transmission unit for transmitting first historical marker content associated with a first historical marker according to an acceptance message sent to the historical content marker request platform and second historical marker content associated with the first historical marker according to predefined parameters selected by the user and stored in a database associated with historical marker content request processing platform; and
a mapping module associated with the historical marker content request processing platform configured to
   compile a first set of directions for the user to travel from the user location to the first marker location according to the GPS coordinates of the user location and the first marker, the historical marker content request processing platform transmitting to the user the first set of directions;
   compile a second set of directions for the user to travel from the user location to a second marker location according to the GPS coordinates of the user location and the second marker, the historical marker content request processing platform transmitting to the user the second set of direction.
Clause 2. The historical marker content request processing platform of any proceeding or preceding clause, wherein the first historical marker content comprises a first category of information pertaining to the first historical marker.
Clause 3. The historical marker content request processing platform of of any proceeding or preceding clause, wherein the second historical marker content comprises a second category of information pertaining to the first historical marker.
Clause 4. The historical marker content request processing platform of any proceeding or preceding clause, wherein the second historical marker content comprises a first category of information pertaining to the second historical marker.
Clause 5. The historical marker content request processing platform of any proceeding or preceding clause, wherein the second historical marker content comprises a second category of information pertaining to the second historical marker.
Clause 6. The historical marker content request processing platform of any proceeding or preceding clause, wherein the first historical marker content comprises visual, audio and textual information pertaining to the first historical marker and stored in a content database associated with a historical marker content server.
Clause 7. The historical marker content request processing platform of any proceeding or preceding clause, wherein the second historical marker content comprises visual, audio, and textual information pertaining to the first historical marker and stored in and transmitted to a third party historical marker content server having content sourced to a third party.
Clause 8. The historical marker content request processing platform of any proceeding or preceding clause, wherein the mobile user device in communication with the historical marker content request processing platform comprises a smart phone having a processor and a dedicated historical marker content platform application stored in associated non-volatile memory of the smart phone.
Clause 9. The historical marker content request processing platform of any proceeding or preceding clause, wherein the mobile user device in communication with the historical marker content request processing platform comprises a person computer having a processor and a dedicated historical marker content platform application stored in associated non-volatile memory of the personal computer.
Clause 10. A method for processing and delivering historical marker content requests from a subscribed user of any proceeding or preceding clause, wherein the predefined parameters of the vehicle damage consist essentially of a number of items in need of repair, a concentration of items in need of repair within the vehicle damage region, a make of the vehicle, a geographic location of the vehicle, and a labor cost associated with the geographic location of the vehicle.
Clause 11. The method for processing and delivering historical marker content requests from a subscribed user of any proceeding or preceding clause, wherein the processor resides in a smart phone.
Clause 11. The method for processing and delivering historical marker content requests from a subscribed user of of any proceeding or preceding clause, wherein the second historical marker content comprises a second category of information pertaining to the first historical marker.
Clause 12. The method for processing and delivering historical marker content requests from a subscribed user of any proceeding or preceding clause, wherein the second historical marker content comprises a first category of information pertaining to the second historical marker.
Clause 13. The method for processing and delivering historical marker content requests from a subscribed user of any proceeding or preceding clause, wherein the second historical marker content comprises a second category of information pertaining to the second historical marker.
Clause 14. The method for processing and delivering historical marker content requests from a subscribed user of any proceeding or preceding clause, wherein the first historical marker content comprises visual, audio and textual information pertaining to the first historical marker and stored in a content database associated with a historical marker content server.
Clause 15. The method for processing and delivering historical marker content requests from a subscribed user of any proceeding or preceding clause, wherein the second historical marker content comprises visual, audio, and textual information pertaining to the first historical marker and stored in and transmitted to a third party historical marker content server having content sourced to a third party.
Clause 16. The method for processing and delivering historical marker content requests from a subscribed user of any proceeding or preceding clause, wherein the mobile user device in communication with the historical marker content request processing platform comprises a smart phone having a processor and a dedicated historical marker content platform application stored in associated non-volatile memory of the smart phone.
Clause 17. The method for processing and delivering historical marker content requests from a subscribed user of any proceeding or preceding clause, wherein the mobile user device in communication with the historical marker content request processing platform comprises a person computer having a processor and a dedicated historical marker content platform application stored in associated non-volatile memory of the personal computer.
Clause 18. The method for processing and delivering historical marker content requests from a subscribed user of any proceeding or preceding clause, wherein the mobile user device in communication with the historical marker content request processing platform comprises a person computer having a processor and a dedicated historical marker content platform application stored in associated non-volatile memory of the personal computer.
Clause 19. A non-transitory computer-readable information storage media, having stored thereon instructions, that when executed by one or more processors in a transceiver, cause to be performed a method comprising:
   a method for processing and delivering historical marker content requests from a subscribed user, comprising:
   identification by a user mobile device position unit that identifies when a mobile device of a user enters a virtual boundary surrounding a first historical marker having a location corresponding to global positioning system (GPS) coordinates, the user mobile device position unit acquiring mobile user device location information for a plurality of uniquely identified users; vehicles having different vehicle damage regions, the vehicle damage information comprising images of vehicle damage information obtained from a depth and dimension measuring device;
   transmitting via a historical marker content transmission unit a first historical marker content associated with a first historical marker according to an acceptance message sent to the historical content marker request platform and second historical marker content associated with the first historical marker according to predefined parameters selected by the user and stored in a database associated with historical marker content request processing platform; and
   compiling via a mapping module a first set of directions for the user to travel from the user location to the first marker location according to the GPS coordinates of the user location and the first marker, the historical marker content request processing platform transmitting to the user the first set of directions; and
   compiling via the mapping module a second set of directions for the user to travel from the user location to a second marker location according to the GPS coordinates of the user location and the second marker, the historical marker content request processing platform transmitting to the user the second set of direction.
20. The non-transitory computer-readable information storage media of any proceeding clause, wherein the first historical marker content comprises a first category of information pertaining to the first historical marker,
   wherein the second historical marker content comprises a first category of information pertaining to the second historical marker.

What is claimed is:

1. A historical marker content request processing platform, comprising:
a processor having an operating system and programmed with executable computer readable code that when executed is programmed to function as:
a user mobile device position unit that identifies when a mobile device of a user enters a virtual boundary surrounding a first historical marker having a location corresponding to global positioning system (GPS) coordinates, the user mobile device position unit acquiring mobile user device location information for a plurality of uniquely identified users; vehicles having different vehicle damage regions, the vehicle damage information comprising images of vehicle damage information obtained from a depth and dimension measuring device;
a historical marker content transmission unit for transmitting first historical marker content associated with a first historical marker according to an acceptance message sent to the historical content marker request platform and second historical marker content associated with the first historical marker according to predefined parameters selected by the user and stored in a database associated with historical marker content request processing platform; and
a mapping module associated with the historical marker content request processing platform configured to
compile a first set of directions for the user to travel from the user location to the first marker location according to the GPS coordinates of the user location and the first marker, the historical marker content request processing platform transmitting to the user the first set of directions;
compile a second set of directions for the user to travel from the user location to a second marker location according to the GPS coordinates of the user location and the second marker, the historical marker content request processing platform transmitting to the user the second set of direction.

2. The historical marker content request processing platform of claim 1, wherein the first historical marker content comprises a first category of information pertaining to the first historical marker.

3. The historical marker content request processing platform of claim 2, wherein the second historical marker content comprises a second category of information pertaining to the first historical marker.

4. The historical marker content request processing platform of claim 3, wherein the second historical marker content comprises a first category of information pertaining to the second historical marker.

5. The historical marker content request processing platform of claim 4, wherein the second historical marker content comprises a second category of information pertaining to the second historical marker.

6. The historical marker content request processing platform of claim 2, wherein the first historical marker content comprises visual, audio and textual information pertaining to the first historical marker and stored in a content database associated with a historical marker content server.

7. The historical marker content request processing platform of claim 3, wherein the second historical marker content comprises visual, audio, and textual information pertaining to the first historical marker and stored in and transmitted to a third party historical marker content server having content sourced to a third party.

8. The historical marker content request processing platform of claim 1, wherein the mobile user device in communication with the historical marker content request processing platform comprises a smart phone having a processor and a dedicated historical marker content platform application stored in associated non-volatile memory of the smart phone.

9. The historical marker content request processing platform of claim 1, wherein the mobile user device in communication with the historical marker content request processing platform comprises a person computer having a processor and a dedicated historical marker content platform application stored in associated non-volatile memory of the personal computer.

10. A method for processing and delivering historical marker content requests from a subscribed user, comprising:
identification by a user mobile device position unit that identifies when a mobile device of a user enters a virtual boundary surrounding a first historical marker having a location corresponding to global positioning system (GPS) coordinates, the user mobile device position unit acquiring mobile user device location information for a plurality of uniquely identified users; vehicles having different vehicle damage regions, the vehicle damage information comprising images of vehicle damage information obtained from a depth and dimension measuring device;
transmitting via a historical marker content transmission unit a first historical marker content associated with a first historical marker according to an acceptance message sent to the historical content marker request platform and second historical marker content associated with the first historical marker according to predefined parameters selected by the user and stored in a database associated with historical marker content request processing platform; and
compiling via a mapping module a first set of directions for the user to travel from the user location to the first marker location according to the GPS coordinates of the user location and the first marker, the historical marker content request processing platform transmitting to the user the first set of directions; and
compiling via the mapping module a second set of directions for the user to travel from the user location to a second marker location according to the GPS coordinates of the user location and the second marker, the historical marker content request processing platform transmitting to the user the second set of direction.

11. The method for processing and delivering historical marker content requests from a subscribed user of claim 10, wherein the first historical marker content comprises a first category of information pertaining to the first historical marker.

12. The method for processing and delivering historical marker content requests from a subscribed user of claim 11, wherein the second historical marker content comprises a second category of information pertaining to the first historical marker.

13. The method for processing and delivering historical marker content requests from a subscribed user of claim 12, wherein the second historical marker content comprises a first category of information pertaining to the second historical marker.

14. The method for processing and delivering historical marker content requests from a subscribed user of claim 13 wherein the second historical marker content comprises a second category of information pertaining to the second historical marker.

15. The method for processing and delivering historical marker content requests from a subscribed user of claim 11, wherein the first historical marker content comprises visual, audio and textual information pertaining to the first historical marker and stored in a content database associated with a historical marker content server.

16. The method for processing and delivering historical marker content requests from a subscribed user of claim 12, wherein the second historical marker content comprises visual, audio, and textual information pertaining to the first historical marker and stored in and transmitted to a third party historical marker content server having content sourced to a third party.

17. The method for processing and delivering historical marker content requests from a subscribed user of claim 10, wherein the mobile user device in communication with the historical marker content request processing platform comprises a smart phone having a processor and a dedicated historical marker content platform application stored in associated non-volatile memory of the smart phone.

18. The method for processing and delivering historical marker content requests from a subscribed user of claim 10, wherein the mobile user device in communication with the historical marker content request processing platform comprises a person computer having a processor and a dedicated historical marker content platform application stored in associated non-volatile memory of the personal computer.

19. A non-transitory computer-readable information storage media, having stored thereon instructions, that when executed by one or more processors in a transceiver, cause to be performed a method comprising:
a method for processing and delivering historical marker content requests from a subscribed user, comprising:
identification by a user mobile device position unit that identifies when a mobile device of a user enters a virtual boundary surrounding a first historical marker having a location corresponding to global positioning system (GPS) coordinates, the user mobile device position unit acquiring mobile user device location information for a plurality of uniquely identified users; vehicles having different vehicle damage regions, the vehicle damage information comprising images of vehicle damage information obtained from a depth and dimension measuring device;
transmitting via a historical marker content transmission unit a first historical marker content associated with a first historical marker according to an acceptance message sent to the historical content marker request platform and second historical marker content associated with the first historical marker according to predefined parameters selected by the user and stored in a database associated with historical marker content request processing platform; and
compiling via a mapping module a first set of directions for the user to travel from the user location to the first marker location according to the GPS coordinates of the user location and the first marker, the historical marker content request processing platform transmitting to the user the first set of directions; and
compiling via the mapping module a second set of directions for the user to travel from the user location to a second marker location according to the GPS coordinates of the user location and the second marker, the historical marker content request processing platform transmitting to the user the second set of direction.

20. The non-transitory computer-readable information storage media of claim 19, wherein the first historical marker content comprises a first category of information pertaining to the first historical marker,
wherein the second historical marker content comprises a first category of information pertaining to the second historical marker.
